(19) United States
(12) Patent Application Publication
(10) Pub. No.: US 2018/0013251 A1
(43) Pub. Date: Jan. 11, 2018

(54) METHOD FOR MANUFACTURING ELECTRICAL INTERCONNECTION STRUCTURE

(71) Applicant: Unid Co., Ltd., Seoul (KR)

(72) Inventors: Yeong Uk SEO, Bundang-gu, Seongnam-si (KR); Yeong Joo MOON, Jungwon-gu. Seongnam-si (KR); Chong Kwang YOON, Sujeong-gu, Seongnam-si (KR); Young Soo KIM, Jungwon-gu, Seongnam-si (KR)

(21) Appl. No.: 15/545,703

(22) PCT Filed: Mar. 20, 2015
(86) PCT No.: PCT/KR2015/002753

§ 371 Date: Jul. 23, 2017

(30) Foreign Application Priority Data
Jan. 22, 2015 (KR) 10-2015-0010482

(51) Int. Cl. H01R 43/00; H01R 12/58; H01R 12/59; H01R 13/24

(52) U.S. Cl. CPC H01R 43/007; H01R 13/2414; H01R 12/58; H01R 12/59

(57) ABSTRACT

Provided is a method of manufacturing an electrical connection structure which includes a female connection structure having an inner conductive material inside an insertion hole of a female connection member, and a male connection structure having a conductive column configured to be inserted into and fixed to the insertion hole to be in contact with the inner conductive material, and formed to protrude from a male connection member. The method includes preparing insulating members used for the female connection member and the male connection member, and forming the inner conductive material and the column by patterning a conductive material on each of the insulating member using a photolithography process.

### TECHNICAL FIELD

The present invention relates to a method of manufacturing an electrical connection structure for electrical connecting between inside and outside portions of printed circuit boards, interposers, electronic packages, and connectors for mutual electrical connecting thereof.

### BACKGROUND ART

An electrical connection structure is required to connect a printed circuit board (PCB) and devices (for example, semiconductive material packages, passive devices, active devices, display modules, and batteries) mounted thereon, or to connect PCBs with other PCBs.

A typical electrical connection structure may be a connector for an electrical connection, and the connector is used for connecting different substrates to each other or for connecting a substrate and electronic components.

Generally, the connector for the electrical connection is a type in which a female connection structure and a male connection structure are coupled to each other, and includes a solder bonding type in which the connector is mounted on a substrate and the like using soldering, and a socket type for detachably coupling.

Generally, the connector for the electrical connection is manufactured to have a specific shape by injection molding a synthetic resin. That is, the connector is formed by a plastic being heated and melted, injected into a mold by high pressure, and cooled to solidify while the pressure is maintained.

When the connector for the electrical connection is manufactured by the injection molding, a great expense is incurred for manufacturing a mold, and there is inconvenience in which a new mold is manufactured again when the design of the electrical connection structure is changed.

In addition, since the connector for the electrical connection is manufactured to be limited to a specific shape (for example, a square shape), the connector should not interfere with structures such as other components or screw holes mounted on a printed circuit board. Thus, there is a problem in which a degree of freedom of circuit design is inhibited because the size of the printed circuit board is increased to increase a mounting space, or a space for connector mounting is considered when a circuit is designed.

### DISCLOSURE

### Technical Problem

The present invention is directed to providing a method of manufacturing an electrical connection structure using a method of manufacturing a printed circuit board in which it is possible for a design to be changed easily and to increase a degree of a mounting location and the effectiveness of a space usage.

The scope of the present invention is not limited to the above-described objects, and other unmentioned objects may be clearly understood by those skilled in the art from the following description.

### Technical Solution

One aspect of the present invention provides a method of manufacturing an electrical connection structure which includes a female connection structure having an inner conductive material inside an insertion hole of a female connection member, and a male connection structure having a conductive column configured to be inserted into and fixed to the insertion hole to be in contact with the inner conductive materials, and formed to protrude from a male connection member. The method includes preparing insulating members used for the female connection member and the male connection member; and forming the inner conductive material and the column by patterning a conductive material on each of the insulating members using a photolithography process.

According to the method of manufacturing an electrical connection structure, the female connection structure is manufactured by following processes including forming the insertion hole in the insulating member, stacking an electrode layer and a first dry film on the insulating member, forming a pattern hole having a shape corresponding to the insertion hole in the first dry film using a photolithography process, filling the insertion hole with a conductive material using an electrical plating process, and forming the inner conductive material by etching the conductive material in the insertion hole.

According to the method of manufacturing an electrical connection structure, the male connection structure is manufactured by following processes including forming an electrode layer and a second dry film on the insulating member, forming a column hole in the second dry film using a photolithography process, and forming the column by filling the column hole with a conductive material using an electrical plating process.

According to the method of manufacturing an electrical connection structure, the male connection structure is manufactured by adding following processes including stacking a third dry film and a fourth dry film on both sides surfaces of the insulating member before stacking the second dry film, forming a pattern hole for forming a pad in the third dry film and the fourth dry film using a photolithography process, and forming the pad by filling the pattern hole in the third dry film and the fourth dry film with a conductive material using an electrical plating process.

According to the method of manufacturing an electrical connection structure, the male connection structure is manufactured by adding following processes including stacking a fifth dry film to cover the columns, forming a pattern hole having a shape corresponding to an elastic fin in the fifth dry film using a photolithography process, and forming the elastic fin by filling the pattern hole in the fifth dry film with a conductive material using an electrical plating process.

According to the method of manufacturing an electrical connection structure, the male connection structure is manufactured by adding following processes including stacking an elastic fin separately manufactured on the columns.

Meanwhile, another aspect of the present invention provides a method of manufacturing an electrical connection structure which includes a female connection structure having an inner conductive material inside an insertion hole of a female connection member, and a male connection structure having a conductive column configured to be inserted into and fixed to the insertion hole to be in contact with the inner conductive materials, formed to protrude from a male connection member, and having an elastic fin around the columns, and the male connection structure is manufactured by following processes including preparing a metal plate used for the elastic fins, forming the column on the metal plate using a photolithography process and a plating process, and stacking an insulating member used for the male connection member on the columns.

According to the method of manufacturing an electrical connection structure the female connection member or the male connection member includes at least one of an active device, a passive device, a connector for electrical connection, a semiconductive material chip package, an interposer applied to a semiconductive material package, a semiconductive material chip and package having a three dimensional multilayered structure, and a multilayered ceramic capacitor.

### Advantageous Effects

An electrical connection structure is manufactured using a method of manufacturing a printed circuit board according to an exemplary embodiment of the present invention in which it is possible for a design to be changed easily and to increase a degree of a mounting location and the effectiveness of a space usage.

Also, according to an exemplary embodiment of the present invention, there is an advantage in which an expense for manufacturing a mold can be saved because conventional injection molding is not used.

In addition, there are effects in that many of the electrical connection structures can be disposed in a small space, and a fine pitch between connection structures can be implemented because of the electrical connection structure described above.

In addition, there are advantages in that an electrical signal speed can be increased by implementing the electrical connection structure in a low height and nearly linear structure, and a signal quality can be increased by reducing a signal loss.

### DESCRIPTION OF DRAWINGS

FIG. 1 is a schematic view illustrating various shapes of an electrical connection structure according to the present invention.

FIG. 2 is a sequential view illustrating a process of manufacturing a female connection structure according to an exemplary embodiment of the present invention.

FIG. 3 is a sequential view illustrating a process of manufacturing a male connection structure according to a first embodiment of the present invention.

FIG. 4 is a sequential view illustrating a process of manufacturing a male connection structure according to a second embodiment of the present invention.

FIG. 5 is a sequential view illustrating a process of manufacturing a male connection structure according to a third embodiment of the present invention.

FIGS. 6 and 7 are cross-sectional views illustrating a detachable electrical connection structure according to an exemplary embodiment of the present invention.

FIG. 8 is a plan view illustrating a column and elastic fins illustrated in FIGS. 6 and 7.

### MODES OF THE INVENTION

An electrical connection structure disclosed in the present invention is a concept which covers all structures for electrical connecting between printed circuit boards applied to all types of electronic devices such as all types of mobile phones, display devices and the like, and electronic devices mounted on the printed circuit board, and a printed circuit board and electrical components. The electrical connection structure is capable of being applied to electronic devices such as all types of mobile phone, and display devices, and in this case, an electrical connection structure of the present invention may be provided in a housing configured to form an appearance of an electronic device. One exemplary embodiment of this may be an electrical connection structure between a printed circuit board installed in a housing and electronic components mounted thereon.

Hereinafter, a detachable electrical connection structure related to the present invention will be described in detail with reference to accompanying drawings.

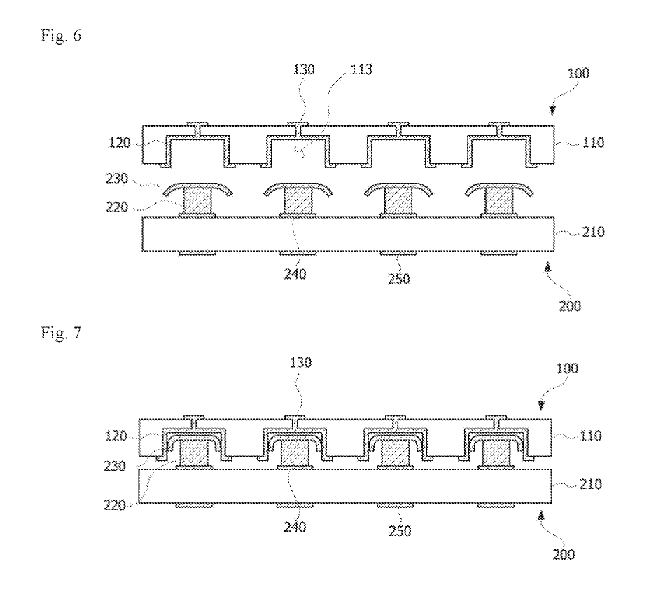

FIGS. 6 and 7 are cross-sectional views illustrating an electrical connection structure according to an exemplary embodiment of the present invention.

As illustrated in FIGS. 6 and 7, an electrical connection structure according to an exemplary embodiment of the present invention includes a female connection structure 100 and a male connection structure 200 coupled to each other by a female and male structure. FIG. 6 illustrates a state in which the female connection structure 100 and the male connection structure 200 are separated from each other, and FIG. 7 illustrates a state in which the female connection structure 100 and the male connection structure 200 are coupled.

The female connection structure 100 and the male connection structure 200 may be formed in the printed circuit board or may be a stand-alone component configured to be mounted on a printed circuit board. For example, the female connection structure 100 or the male connection structure 200 may include at least one of an active device, a passive device, a connector, an interposer applied to a semiconductive material package, a semiconductive material chip package, a semiconductive material chip and package having a three dimensional multilayered structure, and a multilayered ceramic capacitor.

The female connection structure 100 includes a female connection member 110 having insertion holes 113, and inner conductive materials 120 provided in the insertion holes 113.

The female connection member 110 may be formed of an insulating material, or a combination of an insulating material and a conductive material. A raw material of the female connection member 110 may be one or a combination of more than one of a ceramic, a polymer, silicon, glass, a metal and the like.

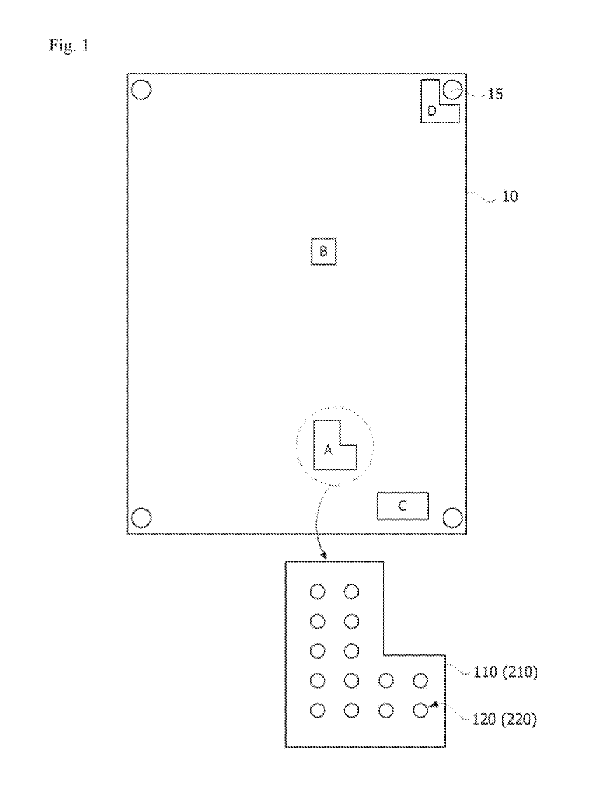

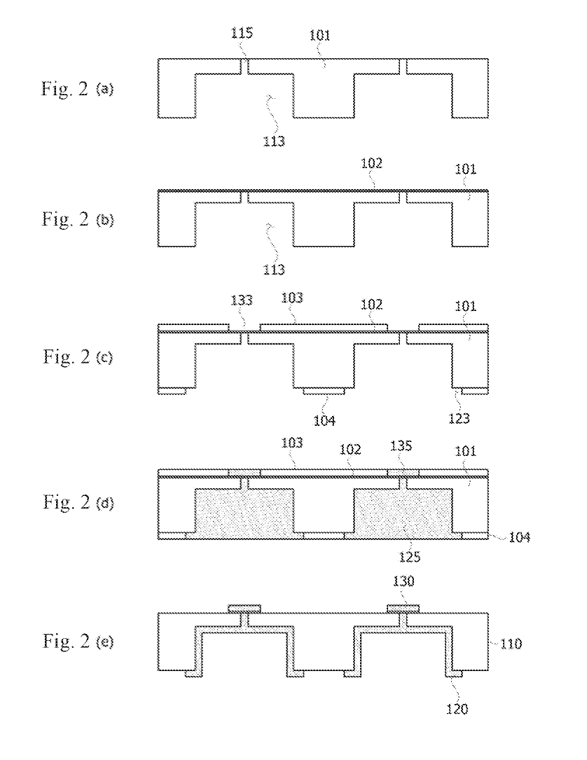

The inner conductive material 120 is provided on an inner wall of an insertion hole 113 formed in the female connection member 110. According to an exemplary embodiment of the present invention insertion, the insertion hole 113 may have a shape resulting from recessing a surface (a lower surface in FIGS. 1 and 2) of the female connection member 110 to a predetermined depth, and may have a recessed shape in the shape of a cylinder. However, the insertion hole 113 may have this shape as well as having a through hole shape completely passing through the female connection member 110.

The inner conductive material 120 may have a shape stacked on the inner wall of the insertion hole 113 at a predetermined thickness. According to an exemplary embodiment of the present invention the inner conductive material 120 is formed along an edge of the inner wall of the insertion hole 113.

The male connection structure 200 includes a male connection member 210, columns 220 protruding from the male connection member 210, and elastic fins 230 extending toward an outer direction from the column 220.

As in the female connection member 110, the male connection member 210 may be formed of an insulating material, or a combination of an insulating material and a conductive material.

The column 220 includes a conductive material and a structure protruding from the male connection member 120. In the exemplary embodiment of the present invention, as an example, the column 220 is mounted on a pad 240 connected to a circuit pattern of the male connection member 210.

The entire column 220 may be formed of a conductive material, or an outside surface thereof may be formed of a conductive material and an inside thereof may be formed of an insulating material. As one example of the latter, the inside of the column 220 may be formed of a polymer, silicon, glass and the like, and only the outside surface thereof may be formed of the conductive material. As illustrated in FIG. 7, the column 220 is inserted into the insertion hole 113 of the female connection member 110 when the female connection member 110 faces the male connection member 210.

The inner conductive material 120 and the column 220 may be disposed in an array shape on the female connection member 110 and the male connection member 210. For example, it is possible for the inner conductive material 120 and the column 220 to be disposed in a matrix shape having a predetermined number of columns and rows, or other various shapes.

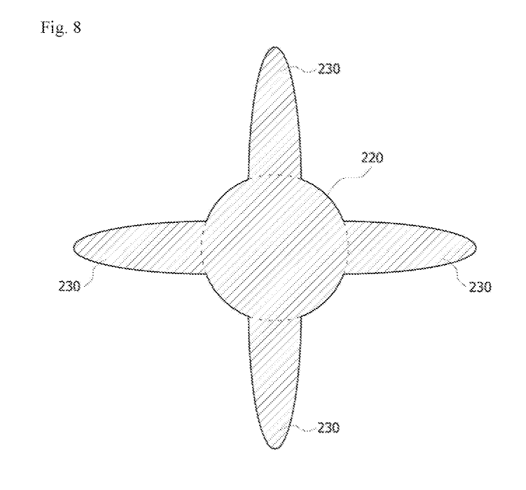

FIG. 8 is a plan view illustrating the column 220 and the elastic fins 230 illustrated in FIGS. 6 and 7.

The elastic fin 230 has a surface having a conductive material and configured to extend outside the column 220. The elastic fin 230 is configured to elastically contact the inner conductive material 120 by being elastically deformed when the column 220 is inserted into the insertion hole 113.

The elastic fins 230 may be bent in a direction opposite to an insertion direction of the column 220 when the column 220 is inserted into the insertion hole 113, and may have an integrated structure with the column 220 or have a configuration in which an additional layer is stacked on an upper surface of the column 220.

The elastic fin 230 may be formed of a conductive material (for example, a metal) capable of being elastically deformed, or may be formed by a surface of an elastic material (for example, a polymer, a fiber) being coated with a conductive material (for example, a metal).

It is preferable to form the elastic fins 230 as a plurality so as to be in contact with a plurality of areas of the inner conductive material 120, and as illustrated in FIG. 8, the plurality of elastic fins 230 may be disposed along a circumferential direction of the column 220 to be spaced apart at a predetermined angle. Even though FIG. 8 illustrates a structure in which the four elastic fins 230 are disposed to be spaced apart at an angle of 90 degrees, it is possible to variously change the number and the shape of the elastic fins 230. For example, the elastic fins 230 may be formed as a plurality or one having a ring shape.

The female connection member 110 and the male connection member 210 respectively include a first connection portion and a second connection portion, and may respectively have a plurality of numbers thereof. The first connection portion and the second connection portion refer to objects configured to be electrically connected by a connection between the female connection member 110 and the male connection member 210, and examples thereof may include pads, circuit patterns, bumps, solder balls, via holes and the like.

According to an exemplary embodiment of the present invention, a pad 130 formed on upper surface of the female connection member 110 is provided as one example of the first connection portion, and a pad 250 formed on a lower surface of the male connection member 210 is provided as one example of the second connection portion.

The inner conductive material 120 formed of a conductive material (for example, a metal) is electrically connected to the first connection portion, and as an example, the inner conductive material 120 in FIGS. 1 and 2 is connected to the pad 130 passing through the female connection member 110 through a bottom of the insertion hole 113.

The column 220 is electrically connected to the second connection portion of the male connection member 210, the pad 250 of the lower surface of the male connection member 210 is capable of being electrically connected through a conductive structure such as a pad 240 of an upper surface of the male connection member 210 and a via hole.

Hereinafter, an operation state of an electrical connection structure of the present invention.

From a state in which the female connection structure 100 and the male connection structure 200 are separated from each other as illustrated in FIG. 6, the female connection structure 100 and the male connection structure 200 may be coupled by the column 220 of the male connection member 210 inserting into the insertion hole 113 of the female connection structure 100 as illustrated in FIG. 7. In the process in which the column 220 is inserted into the insertion hole 113, the elastic deformation of the elastic fin 230 occurs by the elastic fin 230 being pressed by the inner conductive material 120 provided on the inner wall of the insertion hole 113, and thus, the elastic fin 230 is electrically in contact with the inner conductive material 120 due to a restoring force generated by elastic fin 230. The elastic restoring force acts as a coupling force between the female connection member 110 and the male connection member 210, and enables the female connection member 110 and the male connection member 210 not to become arbitrarily separated from each other.

Meanwhile, as the elastic fin 230 electrically connected to the second connection portion of the male connection member 210 is in contact with the inner conductive material 120 electrically connected to the first connection portion of the female connection member 110, it is possible to electrically connect the first connection portion and the second connection portion.

As described above, an additional physical coupling structure is not required due to implementing an electrical connection structure and a physical coupling structure together, and there is advantage in that a total thickness of the electrical connection structure is capable of being decreased by implementing the electrical connection structure in a horizontal contact structure at an inside of the female connection member 110. In addition, there are advantages in that an electrical signal speed may be increased by implementing the electrical connection structure in a low height and nearly linear structure, and a signal quality may be increased by reducing a signal loss.

Meanwhile, even though a structure in which the elastic fin 230 is provided on an outside surface of the column 220 is described as a structure of the male connection structure 200, a structure is possible in which the elastic fin 230 is not provided, and the column 220 is inserted into and coupled to the insertion hole 113, and the column 220 is in directly contact with the inner conductive material 120.

Hereinafter, a method of manufacturing an electrical connection structure according to an exemplary embodiment of the present invention will be described with reference to FIGS. 2 to 5.

A method of manufacturing an electrical connection structure according to the present invention includes an process of preparing insulating members 101 and 201 used for the female connection member 110 and the male connection member 210, and an process of forming the inner conductive material 120 and the column 220 by patterning a conductive material on each of the insulating members 101 and 201 using a photolithography process.

Hereinafter, each of manufacturing processes of the female connection structure 100 and the male connection structure 200 will be described in detail.

FIG. 2 is a sequential view illustrating a process of manufacturing a female connection structure according to an exemplary embodiment of the present invention.

As illustrated in FIG. 2(a), an insulating member 101 used for the female connection member 110 is prepared, and the insertion hole 113 is formed in the insulating member 101. At this time, a conductive hole 115 for electrically connecting the pad 130 and the inner conductive material 120 may be formed at the same time.

Then, an electrode layer 102 is stacked as illustrated in FIG. 2(b). A conductive film such as copper may be used for the electrode layer 102, and this is used for a structure to connect electrodes when electrical plating.

Next, as illustrated in FIG. 2(c), a dry film 104 is stacked, and a pattern hole 123 corresponding to the insertion hole 113 is formed in the dry film 104 using a photolithography process. It is possible to form the pattern hole 123 in the dry film 104 in advance, before adhering to the insulating member 101.

At this time, another dry film 103 is adhered to a side opposite to the insertion hole 113, a pattern hole 133 corresponding to the pad 130 may be formed using a photolithography process. The photolithography processes which form each of the pattern holes 123 and 133 may be performed at the same time.

Next, as illustrated in FIG. 2(d), the insertion hole 113 is filled with a conductive material 125 such as copper using an electrical plating process. At this time, it is possible to fill the pattern hole 133 in a side opposite to the insertion hole 113 with a conductive material 135 at the same time. Thus, a structure for the inner conductive material 120 and a structure for the pad 130 may be formed at the same time by performing the electrical plating process on insides of the insertion hole 113 and the pattern hole 133 in a side opposite thereto at the same time.

Next, as illustrated in FIG. 2(e), a pattern of the inner conductive material 120 is formed by mechanically or chemically etching the conductive material 125 in the insertion hole 113. In addition, the female connection structure 100 is finally completed by delaminating dry films 102 and 104, and removing a part of the electrode layer 102 using a mechanical or chemical etching process.

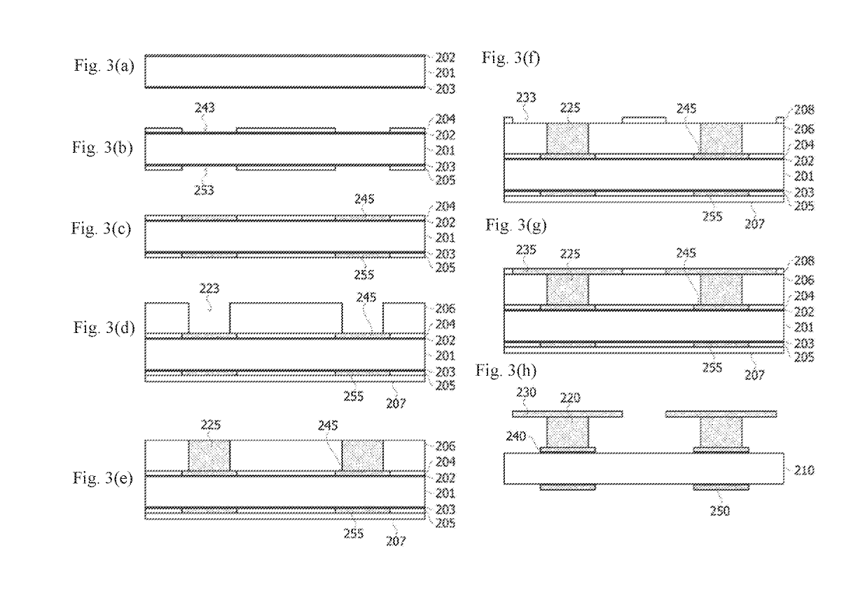

FIG. 3 is a sequential view illustrating a process of manufacturing a male connection structure according to a first embodiment of the present invention.

As illustrated in FIG. 3(a), an insulating member 201 used for the male connection member 210 is prepared, and an electrode layer 202 is stacked on one surface of the insulating member 201. In the case of an exemplary embodiment of the present invention, an electrode layer 203 is also formed on the other surface of the insulating member 201 to form the pad 250 on the opposite surface. In this process, it is possible to form a structure such as a via hole, etc. to electrically connect a top and a bottom surface of the insulating member 201.

Next, as illustrated in FIG. 3(b), dry films 204 and 205 are stacked on outside surfaces of the electrode layers 202 and 203, and pattern holes 243 and 253 are formed to form pads 240 and 250 in each of the dry films 204 and 205 using a photolithography process.

Next, as illustrated in FIG. 3(c), the pads 240 and 250 are formed by filling the pattern holes 243 and 253 of the dry films 204 and 205 with a conductive material such as copper. At this time, the electrical plating process may be performed on an inside of a via hole to electrically connect the pads 240 and 250.

Next, as illustrated in FIG. 3(d), dry films 206 and 207 are stacked on both sides surfaces on which the column 220 is formed and the column 220 is not formed. Then, a column hole 223 is formed in the dry film 206 in which the column 220 is formed. The column hole 223 is also formed using the same photolithography process as the pattern holes 243 and 253 described above. The dry film 207 stacked on a side opposite to the column 220 acts as a barrier so that electrical plating is not further performed.

Next, as illustrated in FIG. 3(e), a column structure 220 is formed by filling the column hole 223 with a conductive material 225 such as copper using an electrical plating process. In the case that the male connection structure 200 does not require the elastic fin 230 to be formed, the male connection structure 200 is completed by the dry films 204, 205, 206, and 207 being delaminated and an unnecessary portion of the electrode layers 202 and 203 being removed. A subsequent process forms the elastic fin 230.

As illustrated in FIG. 3(f), a dry film 208 is stacked to cover the conductive material 225 for the column 220, and a pattern hole 233 having a shape corresponding to the elastic fin 230 is formed in the dry film 208 using a photolithography process.

Next, as illustrated in FIG. 3(g), a structure for the elastic fin 230 is formed by filling the pattern hole 233 with a conductive material such as copper, etc. using an electrical plating process. Next, as illustrated in FIG. 3(h), the male connection structure 200 may be finally completed by the dry films 204, 205, 206, 207, and 208 being delaminated, and an unnecessary portion of the electrode layers 202 and 203 being removed using a mechanical or chemical etching process.

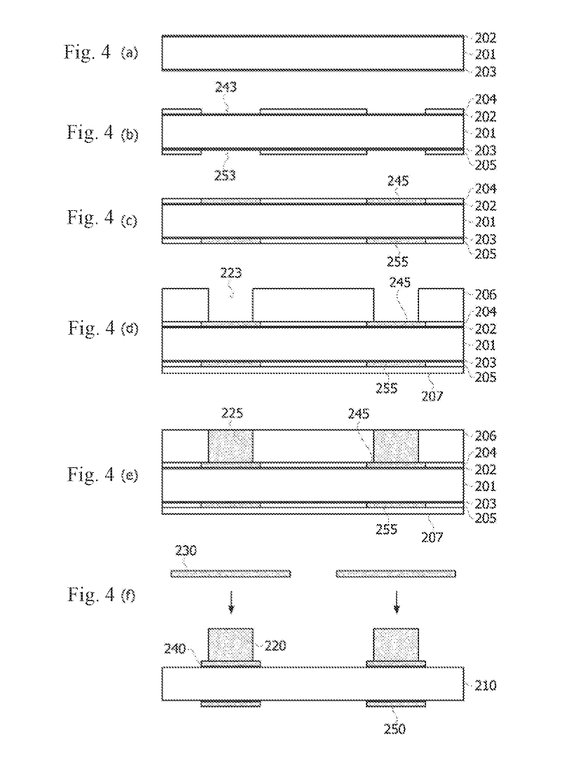

FIG. 4 is a sequential view illustrating a process of manufacturing a male connection structure according to a second embodiment of the present invention.

The male connection structure according to an exemplary embodiment of the present invention has the same process as the previous embodiment except the process of forming the elastic fin 230. That is, processes FIGS. 4(a) to 4(e) are the same as the processes FIGS. 3(a) to 3(e).

The method of manufacturing the male connection structure in this embodiment of the present invention is the same until the process of forming the column 220, since then, as illustrated in FIG. 4(f), the elastic fin 230 separately manufactured is stacked on the column 220.

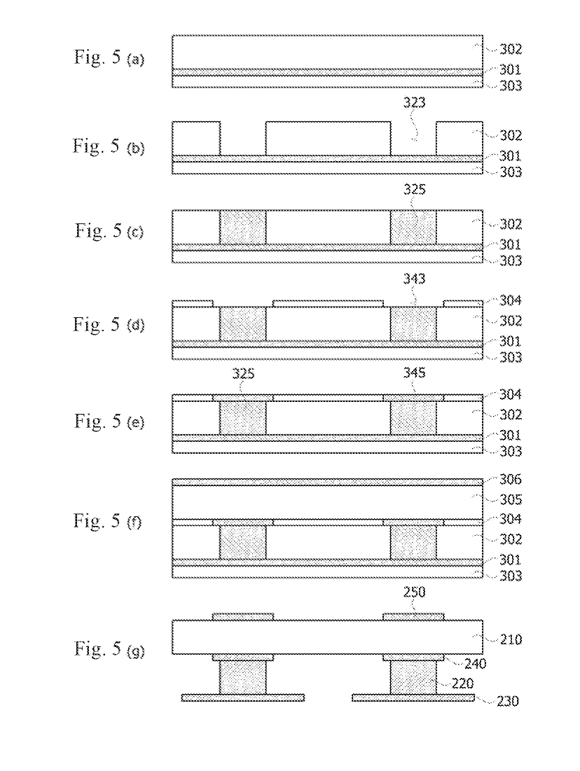

FIG. 5 is a sequential view illustrating a process of manufacturing a male connection structure according to a third embodiment of the present invention.

The method of manufacturing the male connection structure according to an exemplary embodiment of the present invention has a reverse order with the previous embodiments, that is, includes a method in which the column 220 and the insulating member 210 are sequentially stacked on a metal plate 301 used for the elastic fin 230.

As illustrated in FIG. 5(a), the metal plate 301 used for the elastic fin 230 is prepared, and dry films 302 and 303 are stacked on both sides surfaces of the metal plate 301.

Next, as illustrated in FIG. 5(b), a column hole 323 corresponding to the column 220 is formed in the dry film 302 on the one side using a photolithography process, and as illustrated in FIG. 5(c), the column 220 is formed by filling the column hole 323 with a conductive material 325 such as copper using an electrical plating process.

Next, as illustrated in FIG. 5(e), a dry film 304 is stacked, and a pattern hole 343 is formed in the dry film 304 to form the pad 240. Next, the pad 240 is formed by filling the pattern hole 343 with a conductive material 345.

Next, as illustrated in FIG. 5(f), an insulating member 210 used for the male connection member 210 is stacked. A metal layer 306 used for the pad 250 is possible to be stacked on the insulating member 210, and since then, a via hole process and a plating process and the like for the electrical connection thereof may be additionally included.

Next, as illustrated in FIG. 5(g), the male connection structure is completed by the elastic fin 230 and the pad 250 being formed by patterning the metal plate 301 and the metal layer 306 using a photolithography process, and the dry films 302,303, and 304 being removed.

FIG. 1 is a schematic view illustrating various shapes of an electrical connection structure according to the present invention.

FIG. 1 illustrates various shapes of the electrical connection structures A to D mounted on a printed circuit board 10 as an example. In the case in which the electrical connection structure is manufactured using the method of manufacturing a printed circuit board, the female connection member 110 or the male connection member 210 may be manufactured in various shapes, and thus, the design thereof may be changed easily. Thus, a degree of mounting location is increased and the efficiency of the space usage may be increased.

For example, it is possible to design the structure D which avoids an arrangement location of a screw hole 15.

Furthermore, there is an advantage in that the inner conductive material 120 or the column 220 may be disposed in the female connection member 110 or the male connection member 210 in various shapes as illustrated by an enlarged view of the structure A in FIG. 1.

The electrical connection structure and the method of manufacturing the same related to the present invention described above may be applied to various fields such as connectors for electrical connections, semiconductive material package assemblies, mutual connection structures for flip chips, mutual connection structures for capacitors of a multilayer ceramic capacitor (MLCC) and other components (or substrates), etc.

Meanwhile, the electrical connection structure and the method of manufacturing the same described above are not limited to the configurations and the methods of the embodiments described above, and various changes to the embodiments may be made by selectively combining all or a part of each of the embodiments, and the various changes may be made by those skilled in the art without departing from the spirit and scope of the present invention.

1. A method of manufacturing an electrical connection structure which includes a female connection structure having an inner conductive material inside an insertion hole of a female connection member, and a male connection structure having a conductive column configured to be inserted into and fixed to the insertion hole to be in contact with the inner conductive material, and formed to protrude from a male connection member, comprising:
preparing insulating members used for the female connection member and the male connection member; and
forming the inner conductive material and the column by patterning a conductive material on each of the insulating members using a photolithography process.

2. The method of claim 1, wherein the female connection structure is manufactured by the following processes:
forming the insertion hole in the insulating member;
stacking an electrode layer and a first dry film on the insulating member;
forming a pattern hole having a shape corresponding to the insertion hole in the first dry film using a photolithography process;
filling the insertion hole with a conductive material using an electrical plating process; and
forming the inner conductive material by etching the conductive material in the insertion hole.

3. The method of claim 2, wherein a structure configured to form a pad connected to the inner conductive material is electrically plated at the same time when the inner conductive material is electrically plated.

4. The method of claim 1, wherein the male connection structure is manufactured by following processes:
stacking an electrode layer and a second dry film on the insulating member;
forming a column hole in the second dry film using a photolithography process; and
forming the column by filling the column hole with a conductive material using an electrical plating process.

5. The method of claim 4, wherein the male connection structure is manufactured by adding following processes:
stacking a third dry film and a fourth dry film on both sides surfaces of the insulating member before stacking the second dry film;
forming a pattern hole for forming a pad in the third dry film and the fourth dry film using a photolithography process; and
forming the pad by filling the pattern hole in the third dry film and the fourth dry film with a conductive material using an electrical plating process.

6. The method of claim 4, wherein the male connection structure is manufactured by adding following processes:
stacking a fifth dry film to cover the column;
forming a pattern hole having a shape corresponding to an elastic fin in the fifth dry film using a photolithography process; and
forming the elastic fin by filling the pattern hole in the fifth dry film with a conductive material using an electrical plating process.

7. The method of claim 4, wherein the male connection structure is manufactured by adding following processes:
stacking an elastic fin separately manufactured on the column.

8. A method of manufacturing an electrical connection structure which includes a female connection structure having an inner conductive material inside an insertion hole of a female connection member, and a male connection structure having a conductive column configured to be inserted into and fixed to the insertion hole to be in contact with the inner conductive material, formed to protrude from a male connection member, and having an elastic fin around the column,
wherein the male connection structure is manufactured by following processes:
preparing a metal plate used for the elastic fin;
forming the column on the metal plate using a photolithography process and a plating process; and
stacking an insulating member used for the male connection member on the column.

9. The method of claim 1, wherein the female connection member or the male connection member includes at least one of an active device, a passive device, a connector for electrical connection, a semiconductive material chip package, an interposer applied to a semiconductive material package, a semiconductive material chip and package having a three dimensional multilayered structure, and a multilayered ceramic capacitor.

10. The method of claim 2, wherein the female connection member or the male connection member includes at least one of an active device, a passive device, a connector for electrical connection, a semiconductive material chip package, an interposer applied to a semiconductive material package, a semiconductive material chip and package having a three dimensional multilayered structure, and a multilayered ceramic capacitor.

11. The method of claim 3, wherein the female connection member or the male connection member includes at least one of an active device, a passive device, a connector for electrical connection, a semiconductive material chip package, an interposer applied to a semiconductive material package, a semiconductive material chip and package having a three dimensional multilayered structure, and a multilayered ceramic capacitor.

12. The method of claim 4, wherein the female connection member or the male connection member includes at least one of an active device, a passive device, a connector for electrical connection, a semiconductive material chip package, an interposer applied to a semiconductive material package, a semiconductive material chip and package having a three dimensional multilayered structure, and a multilayered ceramic capacitor.

13. The method of claim 5, wherein the female connection member or the male connection member includes at least one of an active device, a passive device, a connector for electrical connection, a semiconductive material chip package, an interposer applied to a semiconductive material package, a semiconductive material chip and package having a three dimensional multilayered structure, and a multilayered ceramic capacitor.

14. The method of claim 6, wherein the female connection member or the male connection member includes at least one of an active device, a passive device, a connector for electrical connection, a semiconductive material chip package, an interposer applied to a semiconductive material package, a semiconductive material chip and package having a three dimensional multilayered structure, and a multilayered ceramic capacitor.

15. The method of claim 7, wherein the female connection member or the male connection member includes at least one of an active device, a passive device, a connector for electrical connection, a semiconductive material chip package, an interposer applied to a semiconductive material package, a semiconductive material chip and package having a three dimensional multilayered structure, and a multilayered ceramic capacitor.

16. The method of claim 8, wherein the female connection member or the male connection member includes at least one of an active device, a passive device, a connector for electrical connection, a semiconductive material chip package, an interposer applied to a semiconductive material package, a semiconductive material chip and package having a three dimensional multilayered structure, and a multilayered ceramic capacitor.
